(19) United States
(12) Patent Application Publication
(10) Pub. No.: US 2018/0083525 A1
(43) Pub. Date: Mar. 22, 2018

(54) METHOD FOR GENERATING HARMONICS FREE DC TO AC INVERTERS

(71) Applicant: AHMED FAYEZ ABU-HAJAR, PULLMAN, WA (US)

(72) Inventor: AHMED FAYEZ ABU-HAJAR, PULLMAN, WA (US)

(21) Appl. No.: 15/272,922

(22) Filed: Sep. 22, 2016

(51) Int. Cl. H02M 1/12; H02M 7/538

(52) U.S. Cl. CPC H02M 1/12; H02M 2001/0009; H02M 7/53803

(57) ABSTRACT

This invention presents a method that generates a harmonics free AC voltage at a specific frequency, such as 60 Hz, from unregulated DC source by precisely biasing complementary push-pull NOMS and PMOS switches. The precise bias triggering pulse is continuous pulse that is created using a feedback linear regulator. Since the feedback linear regulator uses low power electronics such as op-amps and comparators, the bias triggering pulse is stepped up using low power step-up transformer for high voltage applications. The step-up transformer is used to step-up the bias triggering pulse at the output of the feedback amplifier to drive the solid state switches precisely so that the output is harmonic free sine wave. In order to minimize the power losses by the switches, two DC-DC converters are used to control the voltages across the NMOS and PMOS switches. One DC-DC converter generates a positive voltage that is connected to the drain of the NMOS switch; where its voltage follows the output voltage during the positive half cycle of the load's current. The other DC-DC converter generates a negative voltage that is connected to the drain of the PMOS switch and it follows the output voltage during the negative half cycle of the current. Hence, a power factor controller is not needed as the NMOS automatically conducts when the load current is positive and the PMOS automatically conducts when the load current is negative. This method is applicable to a single phase as well as three phase system, and for a standalone load as well as for grid connected load. Also, this method does not require the need for a high power filter or bulky inductors to remove the harmonics as the harmonics are removed by precisely biasing each switch during its conduction.

### CROSS-REFERENCE TO RELATED APPLICATIONS

Not applicable.

### BACKGROUND OF THE INVENTION

This invention pertains generally to the field of electrical power conversion and particularly to DC to AC inverters using solid state switches. In this invention, a method for generating a harmonics free DC to AC inverter is created without using costly multilevel inverters and/or very large inductors to filter out the harmonics. Instead, this invention uses a voltage regulator, using a reference pure sine wave in a feedback loop, to generate a precise bias triggering pulse at the gates of the solid state switches. The precise bias triggering pulse is created such that it generates harmonics free sine wave at the output. In this invention, the bias triggered pulse is stepped up to high voltage, if needed, using very low cost and low power transformer or a cascaded sequence of series transformers. The step-up transformer sends an amplified voltage of the precise bias triggering pulse to the gates of the solid state switches such that a high voltage harmonics free sine wave is generated at the output. Unlike multilevel inverters, which uses on/off switching and cannot generate in practice harmonics free sine wave at the output, this invention uses continuous biasing pulse that is capable on generating harmonics free sine wave at low costs.

### BRIEF SUMMARY OF THE INVENTION

Most modern renewable energy systems, such as wind and solar systems, use an intermediate dc bus and/or a battery storage system. The intermediate captured DC energy is then inverted to AC and synchronized with the grid. Current state-of-the-art DC to AC inverters use pulse width modulation techniques with on/off switching combined with multilevel inverters to generate near sinusoidal output at 60 Hz, 50 Hz or 400 Hz. However, the generated output contains harmonies due to the finite number of levels and the on/off switching. Hence, prior arts use of expensive filters and large inductors combined with advanced pwm techniques with on/off switching.

This invention presents a method for generating a harmonics free sinusoidal voltage from unregulated DC voltage source using a feedback amplifier that is compared to a pure sine wave reference signal to generate a continuous and precise biasing triggering pulse. If needed, the precise bias triggering pulse is amplified to higher voltages using low power transformer. The feedback amplifier is called a voltage regulator, as it regulates the voltage at the output to be harmonics free sine wave. The voltage regulator sends the precise bias triggering pulse to the gates of a pair of complementary NMOS and PMOS switches. Other complementary solid state switches can be used such as BJTs or IGBJs. The precise bias triggering pulse generates pure sine wave at the output or the load. MOSFETs are used because of their speed and their gates require very small leakage current. Hence, a very low power rating transformer is sufficient to trigger the switches at high voltages. Hence, a harmonies free sinusoidal power signal is generated at the output because of the feedback loop of the regulator. This invention uses two complementary solid state switches (NMOS & PMOS) in a push-pull configuration, so that they alternate conducting the current for the positive and negative current's half cycle. Because of that, this method is automatically capable on supplying the load with pure sinusoidal voltage at any power factor.

The method of this invention uses two rails voltages that are regulated or controlled to minimize the power losses across the two complementary switches (NMOS & PMOS). Hence, two DC-DC converters are used to regulated the rails voltages, V+ and V−, such that the voltage across each switch is minimized and by making V+ is greater than the load's output voltage and by making and V− to be less than the load's voltage. This is obtained by controlling the DC-DC converters so that the unregulated DC voltage is converted into two regulated or controlled voltages that follow the load voltage accordingly.

### BRIEF DESCRIPTION OF DRAWINGS

FIG. 1 illustrates a block diagram schematic of the overall invented system

FIG. 2 illustrates an embodiment of the invented single phase DC to AC inverter with two complementary solid state switches, NMOS and PMOS

FIG. 3 illustrates the wave forms of the load voltage, the load current and triggering pulse of the solid state switches at a lagging power factor

FIG. 4 illustrates an exemplary circuit for the invented voltage regulator with a negative feedback amplifier and a low power rating step-up transformer.

FIG. 5 illustrates an exemplary embodiment of a control unit that uses a microcontroller to control the operation of the invented system

FIG. 6 illustrates the use of two DC-DC converters to regulate and control the rail-to-rail voltages for the two switches.

### DESCRIPTION OF EMBODIMENTS OF THE INVENTION

The details of this invention that are indicated in the background as well as the description herein are identified for the purpose of providing an in depth and detailed understanding of this invention. It should be clear that the exemplary embodiments may be practiced without these specific details that are described in those embodiments. In other instances, the use of the type of switches, amplifiers, and components are not limited from the ones that are shown in diagrams to facilitate the description of the exemplary embodiments. The exemplary embodiments are used herein for the purpose of illustrating certain details of this invention. However, the drawings should not be taken as imposing any limitations that may be present in the drawings. The embodiments may be implemented using an existing computer processor, or by a special purpose computer processor incorporated for this or another purpose, or by a hardwired system.

Technical effects of the method disclosed in the embodiments include enabling the production of single phase as well as three phase inverters that require fewer power devices and electronics while maintaining the harmonics free output voltage at the load without using filters and/or bulky inductors. This allows for the reduction in size, weight and costs, at higher power level which is particularly advantageous in renewable energy applications.

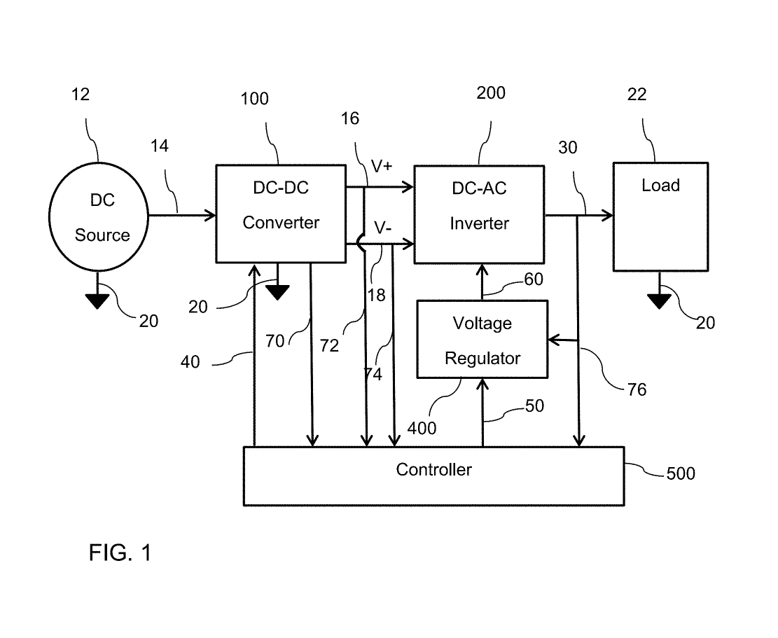

FIG. 1 illustrates a block diagram schematic of the invented method that is a harmonics free DC to AC inverter 10 for single phase system. However, this invention can be applied to three phase systems as well. The invented DC to AC inverter includes an unregulated dc voltage source 12, such as a battery, a fuel cell, a photovoltaic solar panel, a DC grid or any other DC voltage source. The system has a ground (neutral node) 20. The ground 20 is the same throughout the entire system, unless isolating grounding is used. The unregulated DC source 12 supplies an unregulated DC voltage 14 that may be a positive single line DC voltage or a two phase DC voltage source where one phase has positive voltage and the other phase has a negative voltage. The unregulated DC voltage 14 is sent to a DC-DC converter 100. The DC-DC converter 100 generates two regulated or controlled voltages, V₊ 16 and V₋ 18, using any two DC-DC topologies that are suitable for the voltage levels of unregulated DC voltage 14 as well as the regulated voltages V₊ 16 and V₋ 18. The DC-DC converter 100 provides regulated voltage by receiving a pwm control signal 40 from a control unit 500 to the DC-DC converter 100. The control signals 40 use rectangular pulses that are varied by the duty cycle and frequency to meet the demands of the regulated voltages V₊ 16 and V₋ 18 at different load currents. The control unit 500 receives voltage and current measurements 70, 72 and 74 from the DC-DC converter 100 as well as the regulated voltages measurements V₊ 16 and V₋ 18. A DC-AC inverter 200 converts the regulated DC voltages V₊ 16 and V₋ 18 to harmonics free sinusoidal voltage at the load 30. The DC-AC inverter 200 receives a precise bias triggering pulse from a voltage regulator circuitry 400, and the bias triggering pulse 60 accommodate for the biasing requirement to turn on the solid state switches such that the output voltage at the inverter 30 is harmonics free sinusoidal voltage. This technique may be applied on a single phase system, on a three phase system and on a poly phase system. The voltage regulator 400 is responsible for sending the bias triggering pulse 60 to the DC-AC inverter 200. The voltage regulator 400 uses a voltage feedback amplifier to compare the measured output voltage 76 of the AC-DC inverter 200 with a reference pulse sine wave signal 50 that comes from the control unit 500. The control unit generates a reference signal at 60 Hz, 50 Hz or 400 Hz by generating a rectangular pulse at the desired frequency such that the pulse width is used control the amplitude of the sine wave at the output. The voltage regulator 400 has low pass filters that filters the rectangular pulse 50 using third order low pass filter to remove all the harmonics. Lower or higher order filter may be used to eliminate all the harmonics. The output of the voltage regulator 400 sends the bias triggering pulse 60 to the solid state switches, such as MOSFETS, BJTs, IBJTs or any solid state switches suitable for this application. In general, the bias triggering pulse 60 require very low power, but it is generated using low voltage electronic circuits such as op-amps and comparators. Hence, it is possible to step up the voltage of the bias triggering pulse using low power rating transformer or a sequence of low power cascaded transformers. Those transformers are small in size and low cost, but they can be used to step-up the bias triggering pulse to very high voltages without damaging the feedback amplifier of the voltage regulator 400. Finally, the control unit 500 is used to control the overall operation. As it the control unit 500 by providing the proper triggering signal 50 that is sent to the voltage regulator 400 by measuring the output voltages and currents at the load 76. Also, the control unit 500 controls the regulated DC voltages V₊ 16 and V₋ 18 such that the power dissipated across the switches in the DC-AC inverter 200 is minimized. Hence, the control unit 500 adjusts the frequency and duty cycle of the pwm pulses of the DC-DC converter 100. Depending on the circuit topology of the DC-DC converter 100, the control unit may adjust the switching frequency according to the load's currents, such that at higher load current higher frequencies are used. Also, the duty cycle of the pwm pulses that are sent to the DC-DC converter 100 is used to regulate voltages V₊ 16 and V₋ 18. This technique is used to properly adjust the voltages across the solid state switches such that the power dissipation across the DC-AC inverter 200 is minimized.

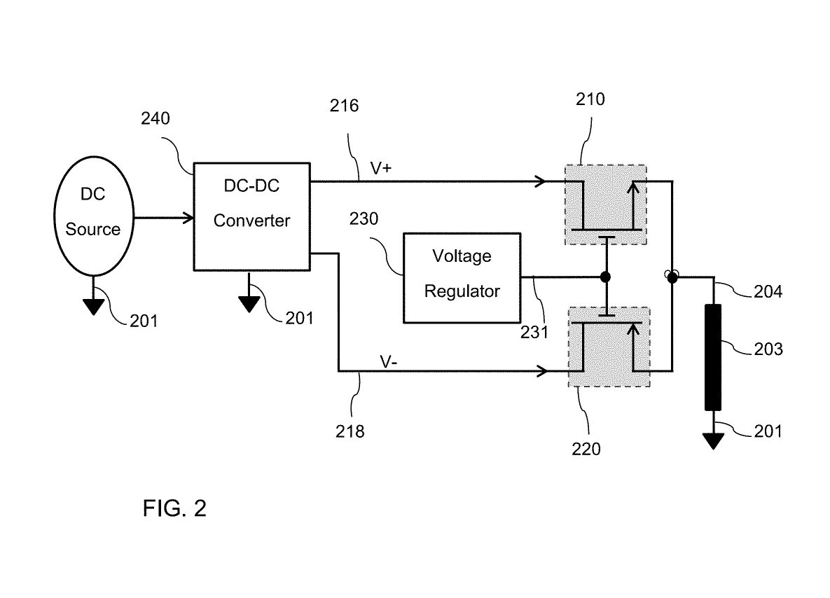

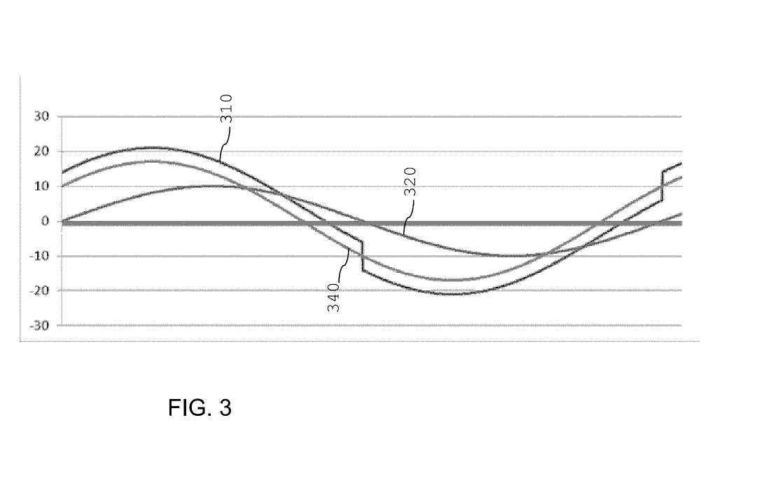

FIG. 2 illustrates an embodiment of a single phase DC-AC converter 200 with two complementary solid state switches, NMOS 210 and PMOS 220. The MOSFET solid state switches herein were chosen to assure that the gates' currents that are supplied by a bias triggering pulse 231 of the voltage regulator 230 requires very low power. However, any other complementary switching devices, such as PNP and NPN or IGBJTs, may be used as long as the voltage from the bias triggering pulse 231 and the load 203 are determined by the load current and the desired supply voltages V₊ 216 and V₋ 218. Because the voltage-current relationship of a solid state switches, i.e. NMOS 210, is a function of the voltage of bias triggering pulse 231, and the load's voltage and current 204 as well as the regulated voltage V₊ 216, then the load voltage at 204 may be easily controlled by sending the proper triggering pulse 231 for a given voltage at V₊ 216. Here, the NMOS 210 is used as a voltage controlled device that permits the current to flow in the positive direction. The same reasoning is also used at the complementary device, i.e. PMOS 220. With a small difference that is the PMOS 220 passes the current in the opposite direction, a negative load current. Another advantage of using of this system is that the switches of 210 and 220 take turns when the load current at 204 reaches zero. This is an attractive feature as it reduces the stress on the switching devices at high load current at 204; specially, at unity power factor because the switching occurs when both the voltage and the current are zero. Under non-unity power factor, that is when the load's current at 204 is out of phase of the voltage, still the switching occurs at zero current but the voltage may not be zero, i.e. when the load has a lagging or leading power factor. Under these conditions, the current will flow through the NMOS 210 as long as the current is positive and the complementary PMOS 220 will be off, as the voltage is reversed biased. But when the load's current at 204 becomes negative, at the zero crossing, the bias triggering pulse 231 jumps to a new biasing point to turn on the complementary PMOS transistor 220. FIG. 3 illustrates an exemplary of the triggering pulse as it jumps from one value to another at the zero crossing of the current, even at a lagging, or leading, power factor. As in FIG. 2, the biasing triggering pulse 231 is send by the voltage regulator 230, where an exemplary triggering pulse is shown in FIG. 3. The bias triggering pulse 310 is shown to be discontinuous as it jumps from one value to another at zero crossing of the current 320. This occurs when the load currents are swapped between the two devices at the zero current crossing. Also, the bias triggering pulse 310 has an additional DC biasing voltage that is higher than the load's voltage 340, when the current is positive. But the triggering pulse 310 is lower than the load's voltage 340 when the current is negative. The voltage difference is required to bias the switches based on the regulated voltages V₊ and V₋ as well as the load current. The architecture shown in FIG. 2 reduces the stress on the switches, especially at unity power factor as the voltage and the currents have zero crossing at the same time.

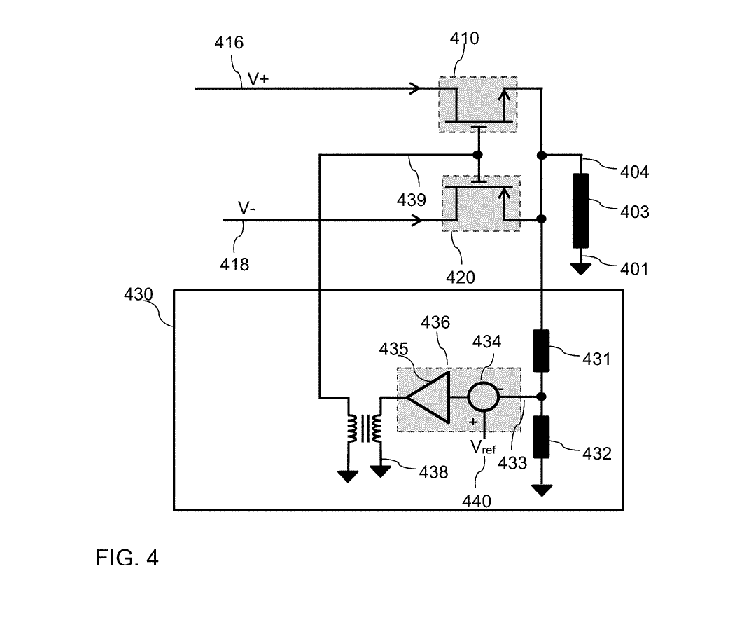

FIG. 4 illustrates a single phase exemplary circuit for a voltage regulator that uses a negative feedback loop linear amplifier 436 and a very low power step up transformer 438. In FIG. 4, a positive regulated voltage V₊ 416 supplies the drain of an NMOS transistor 410; similarly, a negative regulated voltage V₋ 418 supplies the drain of a complementary PMOS transistor. The sources of the NMOS and the PMOS transistors are jointly connected at 404 to supply the load 403 with power. The solid state switches can be chosen to be of any type, but MOSFETs were used here to reduce the power required by the bias triggering pulse at the gates 439. The voltage regulator 430 is responsible for regulating the load voltage to generate harmonics free sinusoidal voltage at the load by sending a precise regulated voltage at the gates of the MOSFETs. For example, the voltage at the load can be chosen to be 120 Vrms, 210 Vrms, 480 Vrms, 1200 Vrms, or any other value. This architecture may be also used for high voltage as well as for low voltage systems. The voltage regulator 430 may use a voltage divider network 431 & 432 that senses the voltage at the load 404, or by using any other technique such as using relays especially for high voltage applications. The impedance of the 431 and 432 are chosen to be very high in order to minimize power losses. Also, the impedance of 431 is larger than 432 such that the sensed measured voltage at 433 is low enough to be handled by the electronic circuitry of the linear feedback amplifier 436. The feedback amplifier uses a series-shunt negative feedback amplifier topology, where the sensed voltage at 433 is subtracted from the reference voltage 440 at the 434. The difference of the two voltages, technically known as the error signal, is amplified using a forward path linear amplifier 435. The output of the forward path linear amplifier 435 is then stepped up using step up transformer 438. If the output of the forward path linear amplifier has some DC offset, it can be easily blocked by placing a DC block capacitor between the forward path amplifier 435 and the low power step up transformer 438. If higher order harmonics exists at the output of the transformer due to the nonlinearity of the transformer caused by the nonlinear hysteresis effect and core saturation of the transformer, or due to the nonlinearity of the forward path amplifier 436, or any other non-linear behavior within the forward path, then a low pass filter at the output of the transformer is placed to remove all those higher order harmonies. The step up transformer 438 is used whenever the amplifier is not able to supply high voltage biasing triggering pulses. In low voltage applications, as in when the forward path amplifier 436 can provide triggering pulses, the step-up transformer 438 maybe removed, only when the feedback amplifier 436 is able to generate high voltage triggering pulses 439 without being damaged. At very high voltages, cascaded step-up transformers maybe used. The advantage of using step-up transformers here is that they require zero current; hence, it requires zero power to trigger the gates of the solid state devices 416 and 418.

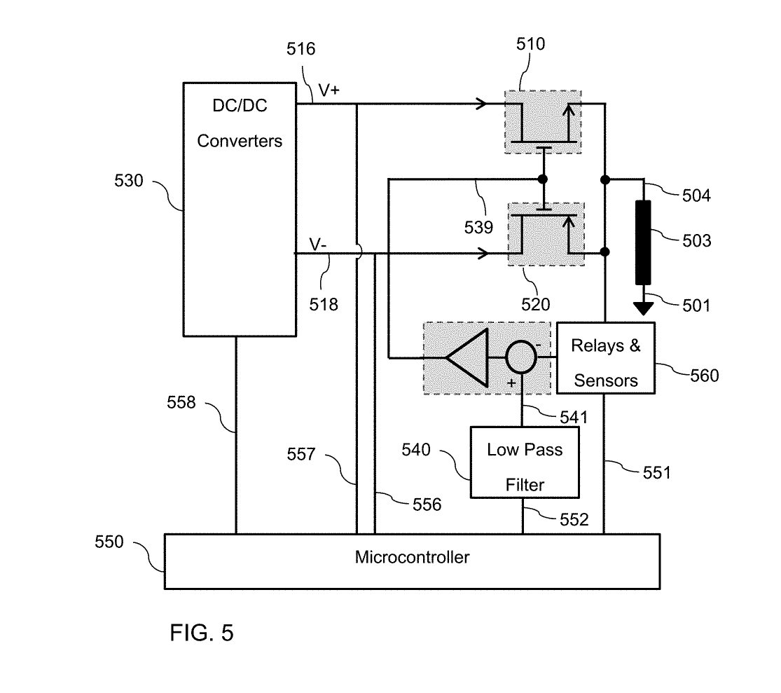

FIG. 5 illustrates an exemplary embodiment of a controller for the invented harmonics free DC to AC inverter. The controller comprises of a microcontroller 550, as a computation device for this system; but the controller may contain multiple microcontrollers or other computational devices such as microprocessors, graphical processing unit (GPUs), computers or data acquisition systems. The microcontroller 550 controls the reference sine wave signal by generating a rectangular pulse 552 with a specific duty cycle at the grid's frequency. The grid's frequency is typically 50 Hz, 60 Hz or 400 Hz. This rectangular pulse is passed through a low pass filter 540 to eliminate all higher order harmonics; hence, it generates pure sine wave that is used as a reference signal 541. A third order bandpass active filter using two op-amps was found to be sufficient to generate the reference signal 541 with near zero harmonics and very small total harmonics distortion. A second order filter may generate an acceptable sine wave, and higher order filter, such as fourth order filter, may also be used to eliminate all higher harmonics to an acceptable level defined by the standard IEEE 519-1992. The microcontroller 550 controls the amplitude of the reference signal 541 by adjusting the duty cycle of the generated rectangular pulse 552. The phase of the generated reference voltage in 541 is controlled by adjusting the starting time of the rising edge of the generated rectangular pulse 552. Hence, the controller may be synchronized with the grid, in terms of the phase and the amplitude. Hence, the microcontroller controls the output voltage at the load 504 by controlling the starting time of the rising edge time and the falling edge of the rectangular pulse 552. Also, the controller measures the voltage and current at the load 504 by using a relays and sensors network 560, which includes relays, voltage dividers Hall current sensors and/or any other sensing network topology. Those measurements 551 are converted into digital representation using analog-to-digital converter, typically they are built-in within the microcontroller or other computation devices. Those measured values are used to control the DC-DC Converters 530 by sending the proper pulse width modulated signals 558 to regulate the voltages V₊ 516 and V₋ 518. In this invention, the DC-DC converters 530 generate V₊ 516 and V₋ 518 such that the voltage across the solid state switches NMOS 510 and PMOS 520, or any other switching devices, are optimal for minimizing the power dissipation across those devices. Based on that, the triggering pulse 539 and the regulated voltages in addition to the load currents need to be adjusted such that the power dissipated across the solid state devices are minimized without exceeding the maximum safe ratings of the devices.

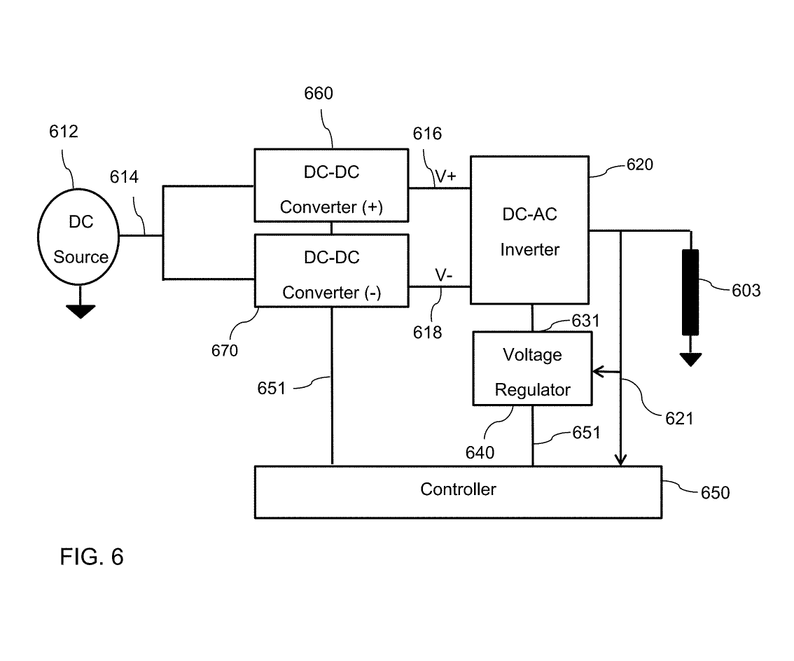

FIG. 6 illustrates an exemplary embodiment of using two DC-DC converters. The first one is a DC-DC converter (+) 660 that is responsible for generating a positive regulated voltage V₊616, and the second one is a DC-DC converter (−) 670 which is responsible for generating a negative regulated voltage V₋ 618. The positive regulated voltage is going to be varying with time such that the power dissipated across the NMOS switch is minimized. Also, the negative regulated voltage is going to vary with respect to time such that the dissipated power in the PMOS switch 620 is minimized. This is achieved by varying the frequency and the duty cycle of the pwm of the positive DC-DC converter (+) 660 and the negative DC-DC converter (−) 670.

This written description uses detailed examples to relate to the invention to enable any person or entity, who is skilled in the field to practice the invention. That includes the making and the using of any device, subsystem or system as well as performing any incorporated methods. The patentable scope of the invention is defined by the claims, and may include other examples that occur to those skilled persons. Such other examples are intended to be within the scope of the claims if they have structural elements that do not differ from the literal language of the claims, or if they include equivalent structural elements with insubstantial differences from the literal languages of the claims.

What is claimed is:

1. A method for delivering a harmonics free AC power from an unregulated DC power source which is comprising of: an unregulated DC voltage source, a positive voltage (V+) DC-DC converter, a negative voltage (V−) DC-DC Converter, two complementary switches (NMOS and PMOS), a feedback linear regulator, a load, a control unit and a sensors network.

2. The method in claim 1 wherein receives unregulated DC power from an unregulated DC solar power, a battery uninterruptable power supply, a wind power source or DC generator.

3. The method in claim 1 wherein supplies a harmonics free AC power to a standalone load or to grid at 60 Hz, 50 Hz, 400 Hz or any other specific frequency.

4. The method in claim 1 wherein has two complementary switches, the NMOS switch and the PMOS switch, where the gates of both switches are tied together and the sources of both switches are tied together and connected to the load or the grid.

5. The method in claim 1 wherein the positive voltage (V+) DC-DC converter receives power from the unregulated DC source and supplies the drain of the NMOS switch with a time varying voltage during the positive half cycle of the load's current.

6. The method in claim 1 wherein the negative voltage (V−) DC-DC converter receives power from the unregulated DC source and supplies the drain of the PMOS switch with a time varying voltage during the negative half cycle of the load's current.

7. The method in claim 1 wherein a harmonics free AC power is delivered to the load by precisely biasing the gates of the NMOS and PMOS switches using a continuous analog bias triggering pulse.

8. The method in claim 1 wherein the feedback linear regulator generates the precise bias triggering pulse to the gates of the NMOS and the PMOS switches such that the AC voltage at the load is harmonic free sine wave and without using bulky inductors or power filters at the load.

9. The method in claim 1 wherein the feedback linear regulator compares voltage at the load to a harmonics free reference signal to generate an error signal, where the error signal is amplified using a linear feedback amplifier.

10. The method in claim 1 wherein the feedback linear regulator uses a small size low power transformer or a sequence of cascaded transformers, as the gates of the NMOS and PMOS switches require very low power to be biased, to step up the precise bias triggering pulse to high voltages.

11. The method in claim 1 wherein the NMOS and PMOS switches do not require power factor controlling scheme as the NMOS is automatically conducting during the positive half cycle of the current by being biased by a continuous biasing triggering pulse that is received by the linear feedback regulator; and the PMOS switch is automatically conducting during the negative half cycle of the current by being biased by a continuous biasing triggering pulse that is received by the linear feedback regulator.

12. The method in claim 1 wherein the positive voltage (V+) DC-DC converter supplies the drain of the NMOS switch with a time varying voltage such that the power loss across the NMOS switch is minimized during its conduction.

13. The method in claim 1 wherein the negative voltage (V−) DC-DC converter supplies the drain of the PMOS switch with a time varying voltage such that the power loss across the PMOS switch is minimized during its conduction.

14. The method in claim 1 wherein the control unit generates a harmonics free reference signal at the specific frequency, and the control unit controls the time varying voltages of the positive voltage (V+) DC-DC converter as well as the negative voltage (V−) DC-DC converter.

15. The method in claim 1 wherein the sensor network measures the load voltage, the load current, the NMOS drain voltage and the PMOS drain voltage and them to the control unit.

16. The method in claim 1 wherein the control unit generates a harmonics free reference signal at the specific frequency by generating a period rectangular pulse at that frequency which filters out all undesired harmonics using third order active filter or higher.

17. The method in claim 1 wherein the control unit synchronizes the load's voltage with grid, in a grid connected load, by controlling the start time of the rising edge of the rectangular pulse, and controls the magnitude of the harmonics free reference signal by controlling duty cycle of the pulse at the specific frequency.

18. The method in claim 1 wherein the control unit sends the triggering pwm to the positive voltage (V+) DC-DC converter so that the drain's voltage of the NMOS switch is higher than the load's voltage during the positive half cycle of the load's current.

19. The method in claim 1 wherein the control unit sends the triggering pwm to the negative voltage (V−) DC-DC converter so that the drain's voltage of the PMOS switch is less than the load's voltage during the negative half cycle of the load's current.
